(19) United States
(12) Patent Application Publication
(10) Pub. No.: US 2020/0240820 A1
(43) Pub. Date: Jul. 30, 2020

(54) SYSTEMS AND METHODS FOR FLUID FLOW DETECTION

(71) Applicant: Intellecy, Inc., San Diego, CA (US)

(72) Inventor: Johannes BOERHOUT, San Diego, CA (US)

(21) Appl. No.: 16/744,107

(22) Filed: Jan. 15, 2020

Related U.S. Application Data
(60) Provisional application No. 62/798,988, filed on Jan. 30, 2019.

(51) Int. Cl. G01F 1/38; G01N 35/10; G01N 21/3504

(52) U.S. Cl. CPC G01F 1/383; G01N 2035/1025; G01N 21/3504; G01N 35/1009

(57) ABSTRACT

This disclosure pertains to a system and method configured for detecting fluid flow of a conduit. The method and system include using a flow sensor configured to sense fluid flow energy through the conduit, and a spectral processor in communication with the flow sensor. The spectral processor determines a spectral energy curve (SEC) of the fluid flow by obtaining, utilizing the flow sensor, raw flow data for the conduit and determining the SEC of the fluid flow energy. The method and system for determining fluid flow includes isolating, utilizing the SEC of the fluid flow energy, a flow-born energy of the conduit from an airborne environmental energy of the conduit, and a structural-born energy of the conduit, and detecting fluid flow based on the flow energy of the conduit.

### BACKGROUND

### 1. Field

The present disclosure pertains to a system and method for fluid (liquid or gas) flow detection.

### 2. Description of the Related Art

Commercial solutions for measuring flow in a conduit are known. That flow in a conduit may be measured with a variety of measurement devices is also known. For example, known commercial solutions may use measurement devices such as: flow nozzles, venturi tubes, orifice plates, a pitot tube, a turbine, vortex flows, ultrasonic Doppler flow meters, and positive displacement devices, for example. Many commercial solutions, however, require making alterations to the conduit itself and fail to provide an accurate platform for detecting fluid or gas flow in a conduit without requiring alterations to the conduit.

### SUMMARY

Accordingly, one or more aspects of the present disclosure relate to a method for detecting fluid flow through a conduit. The method includes utilizing a flow sensor configured to sense fluid flow energy. The flow sensor is in communication with a spectral processor configured to determine a spectral energy curve (SEC) of the fluid flow. In some embodiments, detecting fluid flow may comprise obtaining, utilizing the flow sensor, raw flow data for the conduit and determining, by the spectral processor, the SEC of the fluid flow energy. Fluid flow is detected by isolating, by the spectral processor, utilizing the SEC of the fluid flow energy, a flow-born energy of the conduit from an airborne environmental energy of the conduit, and a structural-born energy of the conduit and detecting fluid flow based on the flow energy of the conduit.

Another aspect of the present disclosure relates to a system for detecting fluid flow through one or more conduits. The system includes a flow sensor configured to sense fluid flow energy of the conduit and a spectral processor in communication with the flow sensor. The spectral processor is configured to determine a spectral energy curve (SEC) of the fluid flow by: obtaining, utilizing the flow sensor, raw flow data for the conduit, determining the SEC of the fluid flow energy, and isolating, utilizing the SEC of the fluid flow energy, a flow-borne energy of the conduit from an airborne environmental energy of the conduit, and a structural-born energy of the conduit. In some embodiments, the system detects fluid flow based on the flow energy of the conduit.

Still another aspect of present disclosure relates to a flow sensor configured to generate and transmit output signals conveying information related to flow energy of fluid flow through a conduit. The flow sensor includes a controller coupled with the flow sensor and in communication with a transceiver configured to transmit and receive I/O signals to and from a processor. The processor is configured to determine a flow state of the fluid flow. A coupler is configured to removably attach the flow sensor to the conduit. In some embodiments, a convex shaped interface coupled to the flow sensor is configured to concentrate flow energy through the conduit and conduct the flow energy to the flow sensor.

These and other aspects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 is a schematic illustration of flow detection system for detecting flow in a conduit in accordance with one or more embodiments;

FIG. 2 is another exemplary illustration of a flow detection system for detecting flow in a conduit in accordance with one or more embodiments;

FIG. 3 illustrates a cross-sectional view of a flow sensor in a flow detection system in accordance with one or more embodiments;

FIGS. 4A-4I illustrate diagrams corresponding to one or more embodiments;

FIG. 5A illustrates a method for detecting flow in a conduit in accordance with one or more embodiments;

FIGS. 5B-5K illustrate diagrams corresponding to one or more embodiments of the method for detecting flow of FIG. 5A;

FIG. 6 illustrates a method for detecting flow in a conduit in accordance with one or more embodiments;

FIG. 7 illustrates a method for detecting flow in a conduit in accordance with one or more embodiments;

FIG. 8 illustrates a method for detecting flow in a conduit in accordance with one or more embodiments; and

FIG. 9 illustrates a method for detecting flow in a conduit in accordance with one or more embodiments.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The embodiments described herein may be purposed to obtain an indication of flow (e.g., whether there is flow or not), flow volume, and/or other parameters of a fluid (e.g., liquid or gas) in a conduit without requiring any alterations of the conduit. For example, the system and method described herein are configured such that a conduit does not need to be cut, modified, or rerouted to obtain the indication of fluid flow and/or flow volume. As another example, no conduit needs a special pipe (and/or any other specialized fittings or equipment) installed to be able to monitor fluid flow. The embodiments described herein effectively reject environmental energy noises so that only flow energies of the conduit are recorded and appropriated towards conduit flow energy and flow amount determinations. Doing so enables development, marketing and installation of simple yet effective flow indicator systems. Flow indicator systems in accordance with the embodiments described herein may facilitate, for example: water conservation, leak detection, water appropriation and apportioning, metering, measurement and indications of excessive use, among other operations.

As discussed above, flow in a conduit can be measured with a variety of measurement devices. All or most of these measurement devices require a one or more components to be placed in the fluid (liquid or gas) stream. For an existing fluid (liquid or gas) delivery installation (e.g., pipes in a home, underground pipes, etc.), this would require making alterations to a given conduit. For home owners who wish to monitor water fluid flow, making changes to copper or flexible piping (flex) is a specialty skill whereby the home owner retains the services of a trained and/or licensed plumber.

For gas flow, home owners, however, are generally not permitted to make conduit modifications and must rely on a specialist for installation. This in turn makes the installation of flow monitoring and measurement devices that require pipe changes costly, time consuming and less practical to install by an unskilled person. The degree of difficulty of installation is seen as a barrier to purchase. These examples are not intended to be limiting.

Accordingly, some embodiments described herein utilize a sound or vibration sensor capable of recording flow energy of a conduit as the fluid or gas moves through the conduit. In some embodiments, the sensor may be coupled to the conduit by means of a clamping or other coupling mechanism or may be placed in the vicinity of the conduit so that flow related energies can be recorded. The present system is configured such that this can be done by the home owner (as in the example above) without the use of a plumber or any other skilled installer. The present system is configured such that no alterations to the existing conduit(s) are necessary. The embodiments described herein process the raw sensor signal and determine actual flow energy of the fluid in the conduit and ignore other environmental and/or structural noises that can manifest as flow energies.

There are many benefits of the embodiments described herein. Continuing with the homeowner example above, currently few home owners would consider a flow meter to monitor water (or gas) consumption not only because of installation cost, but also out of fear of creating a weakened, leaky conduit. The embodiments described herein provide a simplified, cost-effective solution for monitoring conduit flow that enables home owners, property managers, water authorities, and the like to gain insight into how much and when water or gas is used. This in turn provides knowledge that may lead to water or gas conservation, leak detection, water appropriation and apportioning, for example.

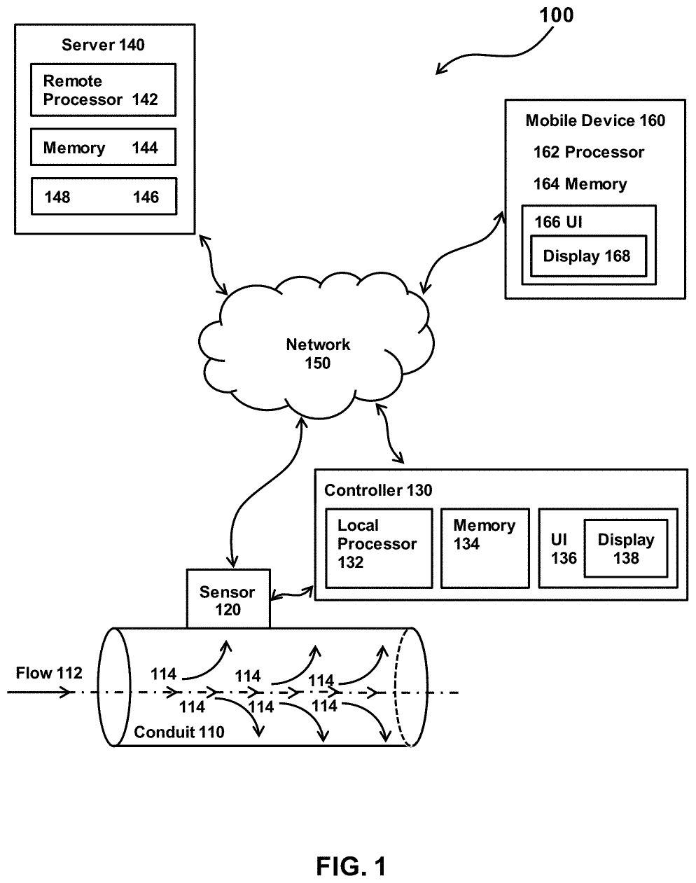

Referring now to FIG. 1, FIG. 1 depicts a schematic of an exemplary flow detection system 100 configured for detecting fluid flow through a conduit 110. In some embodiments, flow detection system 100 may include (and/or be coupled to) conduit 110, flow sensor 120, local controller 130, server 140, network 150, mobile device 160, and/or other components. As shown in FIG. 1, flow sensor 120, local controller 130, server 140, mobile device 160 server 140 may all be in communication with one another communicate via network 150. For example, network 150 may include a LAN/WAN connection configured to provide an Internet connection via a hybrid fiber optic (HFC) transmission network, (e.g., Ethernet twisted shielded pair CAT-5, Wi-Fi, premises coaxial cable network, or any other connection capable of establishing an Internet connection). In some embodiments, network 150 may include a wireless network capable of establishing an internet connection (e.g. 5G, LTE, 4G, CDMA, and the like).

In some embodiments, conduit 110 may communicate fluid flow 112 through conduit 110. Flow 112 may fill conduit 112 completely, or may in some embodiments, fill conduit 112 less than completely full. Flow 112 may include high velocity flows and low velocity flows. As described herein, flow 112 may refer to a liquid flow, a gas flow, a semi-gaseous flow, a semi-liquid flow, and/or other types of flow (e.g., molten flow, pyroclastic flows, and the like).

As shown in FIG. 1, flow 112 flows through the flow path of conduit 110. In some embodiments, conduit 110 may include polyvinyl chloride (PVC) piping, brass, copper, steel, aluminum, iron, concrete glass, or any other material suitable for providing a flow path for a fluid liquid or gas. Flow 112 interacts with imperfections of conduit 110 (e.g., imperfections in a pipe wall). These interactions may be laminar or turbulent each having a different level of interaction, which is discussed in further detail below. This laminar or turbulent flow energy caused by friction forces of flow 112 may be included within flow energy 114.

As shown in FIG. 1, flow energy 114 propagating through conduit 110 may cause fluid-friction within an interior wall of conduit 110. The fluid friction causes small vibrations to resonate within conduit 110. These vibrations may be picked up by flow sensor 120 as acoustic or vibrational energy (e.g., vibrational motion). In some embodiments, flow sensor 120 may utilize a vibration sensor picking up mechanical vibrations and/or acoustical sounds.

In some embodiments, flow sensor 120 may include an-ultrasound-sensor, geophone, hydrophone, lace sensor, microphone, seismometer, sound locater, piezo electric sensors (e.g. accelerometer, gyroscopes, lace sensors, and the like). In some embodiments, flow sensor 120 may include a coil-based sensor (e.g., velometer, dynamic microphone, and the like), an electrostatic capacitor-based sensor (e.g., electret microphone), and/or a magnetometer sensor and/or other sensors (e.g., MEMS sensor). In some embodiments, flow sensor 120 may include a laser-based sensor or camera-based sensor, which do not have a direct mechanical coupling to conduit 120 but do read out a direct dynamic mechanical vibration measurement (e.g., a Doppler effect laser-based sensor or camera-based sensor).

As shown in FIG. 1, in some embodiments, flow sensor 120 may be placed proximal to conduit 110 for optimal detection of flow energy 114. In some embodiments, flow sensor 120 may be mechanically coupled to the conduit. In one embodiment, flow sensor 120 may be mechanically coupled to the top of conduit 110. In another embodiment, flow sensor 120 may be mechanically coupled to the bottom or side of conduit 110. In yet another embodiment, flow sensor 120 may be coupled to conduit 110 within close proximity of pipe bends (i.e., turns, elbows, or windings of a flow path of conduit 110). Placing flow sensor within a close proximity of conduit 110 elbows may increase performance in detecting acoustic or vibrational energy of conduit 110.

In some embodiments, if flow sensor 120 cannot be mechanically coupled to conduit 110, a laser sensor, camera sensor, and/or sound sensor (microphone) may be implemented. For example, the sound sensor may be aimed at conduit 110 and placed as close as possible, but less than 6 inches away. Depending on the environment, the efficacy of a sound-based system rapidly degrades when placing the sound sensor more than a few inches from the conduit (e.g., 6 inches). In some embodiments, utilizing a laser sensor, the flow sensor 120 may be placed 10 m-100 m or more away from conduit 110 without affecting efficacy, depending on the laser quality and the target conduit type (e.g., iron, plastic, steel, etc.).

As discussed in further detail below, flow 112 may cause flow energy 114 (e.g., vibrational energy), to propagate through conduit 110 and be detected by flow sensor 120. In one embodiment, flow sensor 120 may detect flow energy 114 of conduit 110 and transmit output signals to local controller 130. In another embodiment, flow sensor 120 may be configured to measure spectral frequencies up to 500 kHz. The output signals may include raw flow data corresponding to flow energy 114.

In one embodiment, flow sensor 120 may be removably coupled to conduit 110. For example, flow sensor 120 may include a clamping mechanism (not shown in FIG. 1) that may removably couple flow sensor 120 to or proximate to conduit 110, which is discussed in further detail below. In some embodiments, flow sensor 120 may be removably coupled on a top surface (though this is not intended to be limiting as a round conduit may not have a “top” surface) of conduit 110 and may detect acoustic energy propagating through conduit 110. In another embodiment, flow sensor 120 may be stationed near conduit 120, within a predetermined distance of conduit 110.

In some embodiments, flow sensor 120 may include a convex shaped acoustic interface (not shown in FIG. 1) configured to concentrate acoustic energy propagating through conduit 110, which is discussed in further detail below. In some embodiments, flow sensor 120 detects acoustic flow energy 114 and transmits raw flow data to local processor 132. Flow sensor 120 may include functionality for communicating raw flow data to local processor 132. For example, flow sensor 120 may include a wired or wireless transceiver (not shown). In some embodiments, sensor 120 may communicate with local processor 132 utilizing satellite, near field communication (NFC), Wi-Fi, BLUETOOTH™, BLE™, Radio Frequency (RF) and/or ZigBee communication protocols, for example.

As shown in FIG. 1, in some embodiments, local controller 130 may include local processor 132 in communication with memory 134, and a user interface 136. User interface 136 may include a local display 138. In one embodiment, user interface 136 may toggle power to flow sensor 120 via actuating a physical switch or button (not shown). For example, a user (not shown) of flow system 100 may toggle user interface 136 to switch flow sensor 120 on and off. In some embodiments, local display 138 may include a touch and/or non-touch LCD, OLED, or flexible e-paper display. Described in further detail below local display 138 may display a flow indication and a flow volume corresponding to flow 112.

In some embodiments, local controller 130 and/or local processor 132 may include processing circuitry including but not limited to: storage buffers, analog-to-digital converters (ADCs), data registers, field programmable gate arrays (FPGAs), latches, CMOS inverters, interrupt/polling circuitry, timestamping circuitry, and/or other solid-state circuitry (e.g., amplifiers and filters). Described in further detail below, processing circuitry of controller 130 and processor 132 may receive, condition, transform, and process raw flow data from flow sensor 120 and communicate the processed raw flow data to local processor 132. In some embodiments, conditioning and transforming the raw flow data may be performed by other processing components of flow system 100 (e.g., remote processor 142 and/or mobile processor 162).

In some embodiments, local processor 132, remote processors 142, and mobile processors 162 may include one or more of: a digital processor, an analog processor, a digital circuit designed to process information, an analog circuit designed to process information, a state machine, and/or other mechanisms for electronically processing information. Although processors 132, 142, 162 are shown in FIG. 1 as single entities, this is for illustrative purposes only. In some embodiments, processors 132, 142, 162 may include a plurality of processing units. These processing units may be physically located within the same device (e.g., local controller 130, mobile device 160, and/or remote servers 140), or may represent processing functionality of a plurality of devices operating in coordination (e.g., local controller 130, remote server 140, mobile device 160).

In some embodiments, memory 134, 144, 164 may include (not shown in FIG. 1) non-transitory machine-readable instructions configured for executing the exemplary embodiments described herein. Non-transitory machine-readable instructions may include program instructions in source code, object code, firmware, executable code or other formats for performing the exemplary embodiments described herein. In some embodiments, memory 144, 164 may include conventional computer system RAM (random access memory), ROM (read only memory), EPROM (erasable, programmable ROM), EEPROM (electrically erasable, programmable ROM), Flash memory, and/or magnetic or optical disks or tapes.

Some embodiments described herein include a spectral processor. For example, local processor 132 may be a spectral processor. The spectral processor may obtain raw flow data of the conduit detected by an acoustic sensor (e.g. flow sensor 120) placed proximate to or coupled with conduit 110. Utilizing the raw flow data, the spectral processor may determine a spectral energy curve (SEC) of energy 114 corresponding to flow 112 through conduit 110. The SEC may include a power spectral density (PSD) curve or curves derived from such including acceleration, velocity, and displacement curves. In some embodiments, the spectral processing may detect flow volume based on the flow energy of the conduit.

For example, in some embodiments, a non-linear relationship between acquired energy and flow speed may be utilized to determine a flow volume. For example, referring to the start and stop of fluid flow as a flow event, the spectral processor may capture energy flow several times a second (e.g., 5/sec or more or less) and accumulates the total energy for the entire flow event. The total volume of fluid flow (e.g. liquid or gas) that flowed during the flow event may correspond to the total amount of accumulated energy. A predetermined calibration constant (or set of constants) now converts the total amount of accumulated energy to volume.

As many commercial and residential structures includes standardized conduit sizes (e.g., ¾″, 1″, 1.5″) having a pressure anywhere between 50-90PSI and virtually all copper pipe used in these structures have the same or similar internal roughness, therefore a default correction factor will be able to obtain an accurate total volume measurement. Additionally, a user of flow system 100 may provide their own calibration factor using a smart-phone application (e.g., mobile device 160) and observations made with the water meter at street level (e.g., controller 130), thereby further increasing accuracy of flow volume detection.

In some embodiments, the spectral processor may continuously acquire and compute a spectral energy curve (SEC). In another embodiment, the spectral processor may intermittently or periodically acquire and compute the SEC of energy 114. In some embodiments, flow sensor 120 output signals may be smoothed and/or conditioned by the spectral processor prior to the spectral energy computation. For example, prior to determining the SEC, the spectral processor may obtain raw flow data and condition the raw flow data with a smoothing function and/or other signal processing techniques (e.g., noise reduction techniques, etc.). Additionally, in some embodiments, the SEC may be postprocessed with one or more filters (e.g., a brick wall filter, smoothing functions, and the like). In some embodiments, the SEC may be transformed into a derived curve that allows for resource conservation including conservation of memory storage, require less processing and execution cycles, and optimizing downstream processing, which is discussed in further detail below.

In some embodiments, the sample frequency of spectral processor 132 may be chosen (e.g., at manufacture of system 100, by a user via entries or selections made via user interface 136, 166) such that sufficient spectral characteristics of conduit 110 can be detected. Sufficient spectral characteristics may be present when the change between flow and no-flow may be detected. For example, if a continuous SEC measurement shows no change even though flow is cycled through on-off, the sample frequency is too low.

In one embodiment, a frequency for sufficient spectral characteristics may be chosen by first acquiring a calibration measurement with very high sample frequency (e.g. 500 kHz) while impacting conduit 110 with a tool (impact hammer, wood, pipe etc.) Doing so may reveal the pipe structure resonating frequencies, which correlate to the spectral response of flow and no-flow. While pipe structure resonating frequencies are not the same spectral areas that may be excited when actual flow is present, pipe structure resonances affect laminar and turbulent fluid flow and are generally close to the areas of interest in SECs. Accordingly, a sample frequency of spectral processor 132 for sufficient spectral resolution for flow measurements may include several (e.g., 4-7), but at least one (1) of such pipe structure resonant frequencies.

In some embodiments, the spectra of interest do not need to be continuous (i.e., from 0 (zero) to fs (sample frequency)). For example, in some embodiments, e.g. a measurement area between 100 kHz-500 kHz (discarding all spectral content below 100 kHz) is fine and actually works better in industrial setting whereby heavy machinery is in close proximity.

For example, in some embodiments, processing sample frequency may be at least 500 Hz. In some embodiments, processing sample frequency may be less than 500 kHz. In some embodiments, for example in domestic applications, a spectral range 500 Hz-20 kHz (i.e. sample frequency 20 kHz*2.56=51.2 kHz) may be implemented. In some embodiments, spectral ranges go beyond 20 kHz may be measured as a ‘band’ whereby both high pass as well as low pass corners are increased. In some embodiments, for example industrial applications, a 100 kHz to 500 KHz spectral band raw or demodulated with a broad band non-carrier based demodulator may be implemented.

As shown in FIG. 1, remote servers 140 may include remote processors 142, remote memory 144, remote user interface 146 having remote display 148, and/or other components. In some embodiments, remote servers 140 may be configured as a data center having one or more server racks including blade servers each having multiple processors and memory devices contained thereon. Remote servers 140 may be configured to access network 150 and communicate with local controller 130 and mobile device 160 for implementing the exemplary embodiments described herein. Remote memory 144 may be configured as cloud memory via network 150 for providing virtual memory capabilities for flow system 100, physical non-transitory memory, and/or other memory.

For example, in some embodiments, remote servers 140 may obtain flow data (e.g., determined instantaneous SEC and averaged SEC, extracted features of SECs, discussed in further detail below) of conduit 110 and store such flow data in remote memory 144. In one embodiment, remote servers may perform any or all of the functionality of controller 130. In another embodiment remote processors 142 may include one or more spectral processors as described above.

In some embodiments, remote servers 140 may compare SECs of conduit 110 (e.g., instantaneous SECs and/or averaged SECs) for the purposes of apportioning flow to one or more pipes (e.g., conduits 110) if these are closely located. For example, in a single building fed by a single pipe, most sensing locations would be expected to have similar SEC measurements. In some embodiments, remote processors 140 may compare SECs and detect outlier SEC curves. Outlier SEC curves may indicate an installation that needs maintenance or may be unsuitable for use. Remote processors 142 may, in one embodiment, perform any or all of the spectral processing as described above, and further below.

In some embodiments, flow system 100 may include and/or be configured to communicate with one or more mobile devices 160. In some embodiments, a mobile device 160 may include mobile processor 162 in communication with memory 164, and mobile user interface (UI) 166 having mobile display 168. In some embodiments, mobile UI 166 may include physical switches and/or buttons. Mobile UI 166 may toggle power to flow sensor 120 via actuating a physical switch or button (not shown). For example, a user (not shown) of flow system 100 may toggle mobile user interface 166 to switch flow sensor 120 on and off. In some embodiments, mobile device 160 may communicate with controller 130 and obtain an indication of flow and flow volume from stored in memory 134. Mobile device 160 may display the indication of flow and flow volume on mobile display 168.

In some embodiments, mobile device 160 may be used to store historical data and compare historical data against current data to establish trends or abnormal situations. Mobile device 160 may display historic/current flow data, data trends, on/off flow and volume, alert times and conditions occurred. In some embodiments, mobile device 160 may be used to manually actuate a shutoff valve and/or override a connected automatic shutoff valve of flow conduit 110 (not shown). For example, in industrial applications, an operator may want to obtain a camera picture of the area where high flow is measured to check for bursts and malfunctioning piping.

As discussed above, in some embodiments, conduit 110 may include a shut-off valve (not shown). The shut-off valve may include a valve device that fits over an existing manual valve handle (not shown) of conduit 110. In another embodiment, the shut-off valve may include an inline valve device that replaces the inline manual valve (not shown) of conduit 110.

In one embodiment, flow system 100 may be configured to automatically actuate the shutoff valve of conduit 110 based on self-computed settings (e.g., utilizing processors 132, 142, 162. For example, self-computed settings may include settings based on flow volume, differential pressure, velocity, volumetric flow, mass flow, turbulent flow condition, cost, time of day/year, power efficiency, and the like. In another embodiment, a user may provide thresholds for the automatic shutoff valve settings. For example, a user may include thresholds based on include settings based on flow volume, differential pressure, velocity, volumetric flow, mass flow, turbulent flow condition, cost, time of day/year, power efficiency, and the like.

As shown in FIG. 1, mobile device 160 may communicate via network 150, to any other parts of system 100 (e.g., remote server 140, local processor 132). Mobile device 160 may include a smart phone, tablet, smart watch, laptop computer, notebook, desktop computer or any other computing device capable of establishing a connection with the Internet and/or other communication networks (e.g., GSM, GPRS, CDMA, GPRS, 2G/GSM, 3G, 4G/LTE, EDGE).

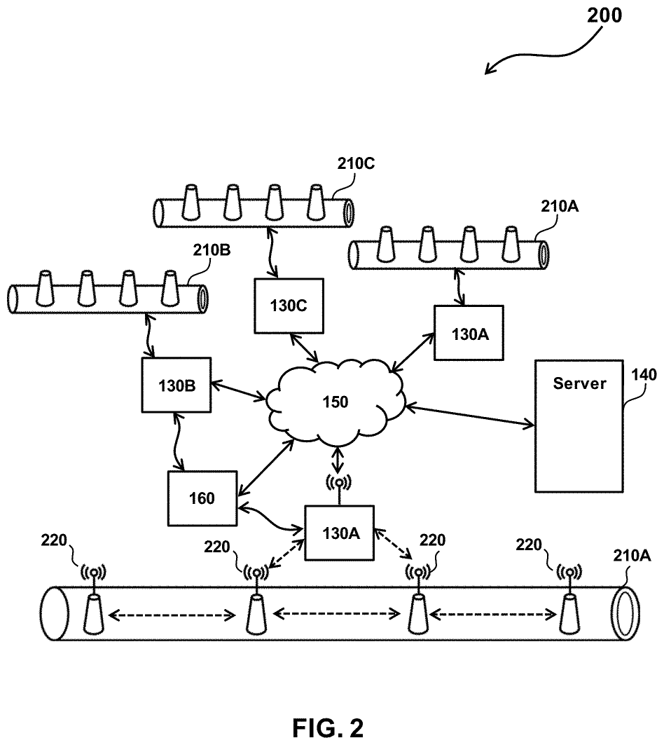

Referring now to FIG. 2, FIG. 2 depicts an exemplary flow detection system 200. Flow detection system 200 is an embodiment of flow detection system 100 of FIG. 1. Flow detection system 200 may operate in a similar manner as flow system 100, in which similarly labeled parts and numbers correspond to similar features having similar functionality. As shown in FIG. 2, flow detection system 200 may differ from flow detection system 100 by having a multitude of conduits 110 and corresponding controllers 130, all performing flow detection with a shared remote server 140.

In some embodiments, flow detection system 200 may be configured for detecting fluid flow through conduits 210a, 210b, 210c through 210n, (hereinafter conduits 210a-n). As shown in FIG. 2, conduits 210a-n each communicate with a a corresponding local controller 130a, 130b, 130c through 130n (hereinafter local controller 130a-n). In some embodiments, n may be between 100-1,000,000 conduits, or more, or less. For example, in one embodiment, system 200 may include tens of thousands of conduits 210a-n and controllers 130a-n. While FIG. 2 depicts a single mobile device 160, flow system 200 may include a mobile device for each pair of conduits 110 and controllers 130. In some embodiments, flow system 200 includes a mobile device 160 for a predetermined number of conduits. For example, a mobile device 160 may have access to a specific group of 10 conduits. The specific group of conduits may include more than 10 conduits or less than 10 conduits, for example.

As shown in FIG. 2, in some embodiments, each conduit 210a-n may include a plurality of flow sensors 220. Flow sensors 220 may be configured to communicate both with adjacent flow sensors 220, and/or local controller 130. For example, in some embodiments, some flow sensors 210 may be within a close proximity of local controller 130 that facilities the use of low-energy communication techniques such as NFC, Bluetooth, RF, and the like. As shown in FIG. 2, sensors 210 that may not be within a close enough proximity of local controller 130 that allows for low-energy communication techniques, may utilize a mesh network (e.g., ZigBee/Z-wave) that allows for sensors 210 to communicate sensor data to local controller 130 via intermediary sensors 210, as shown in FIG. 2.

Local controller 130 may communicate sensor data and/or flow data to remote server 140 via network 150. Remote server 140 may be configured to receive raw flow data and/or SEC information from all conduit and controller pairs (i.e. conduits 210a-n and local controllers 130 a-n). Server 140 may include user data and administrative functionality for managing users of system 200. Managing user data may include, for example, maintaining and updating user personal information, billing information, historical usage, and the like. Server 140 may also be configured for transmitting user alerts in response to detected events such as leakage events, malfunctioning pipes, and excess usage alerts, and the like.

For example, a specific controller 130n may detect a leakage event of conduit 130 and transmit an alert to remote server 140. In response to receiving the alert, remote server 140 may access user data corresponding to the specific controller 130n and transmit an alert to mobile device 160n corresponding to a specific user. In this way, a user of system 200 may receive real-time indications of leakages in conduit 110. Server 140 may transmit other types of reminders and alerts to mobile device 160 in response to indications received by controller 130.

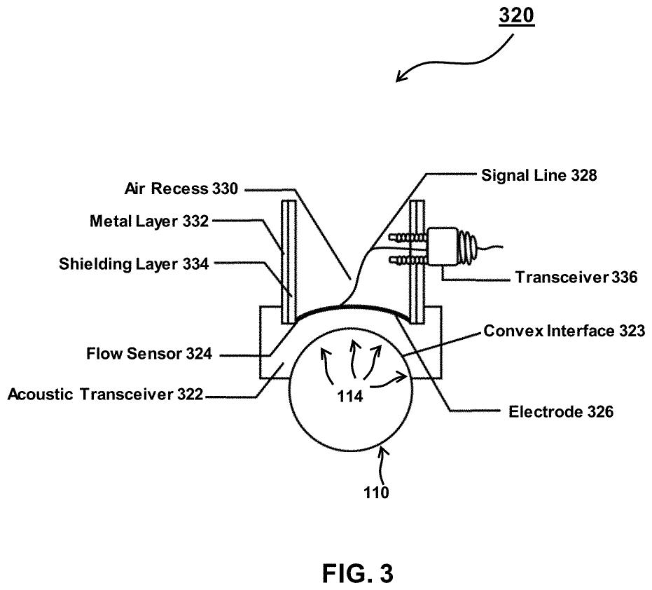

Referring now to FIG. 3, FIG. 3 depicts an end view of an exemplary flow sensor system 320 for detecting flow through conduit 110. Flow sensor system 320 may be and/or include sensor 120 shown in FIG. 1, for example. In some embodiments, flow sensor system 320 may include acoustic transducer 322, flow sensor 324 (e.g., piezo electric composite material), electrodes 326, signal line 328, air recess 330, metal layer 332, shielding layer 334, transceiver 336, and clamping mechanism 338. Flow sensor 324 may generate and transmit output signals conveying information related to flow energy 114 of fluid flow 112 through conduit 110. For example, output signals may include raw flow data corresponding to flow energy 114 flowing through conduit 110.

As shown in FIG. 3, flow sensor system 320 may include acoustic transducer 322 (not drawn to scale in FIG. 3). While shown in FIG. 3 as directly coupled to conduit 110, in some embodiments, acoustic transducer 322 and/or flow sensor 324 (or other sensing material/element) may be not directly coupled to the pipe. For example, in one embodiment, a plastic substrate (not shown in FIG. 3) may be formed around conduit 110 onto which sensing elements (e.g., transducer 322 and/or sensor 324) may be fastened. In some embodiments, transducer 322 and/or sensor 324 may include the plastic substrate.

In one embodiment, acoustic transducer 322 may include convex shaped interface 323. Convex shaped interface 323 may be configured to behave as a convex lens. Convex shaped interface 323 may concentrate acoustic flow energy 114 propagating through conduit 110 onto flow sensor 324 by taking advantage of the physical properties of convex shaped lenses.

Convex shaped lenses focus wave energy propagating through the lens onto a focal point of the convex, (i.e., the peak of the convex). Convex lenses utilize refractive properties of wave propagation to bend incoming propagating wave energy onto the focal point of the convex. Taking advantage of the natural properties of convex lenses and concentrating acoustic energy 114 onto flow sensor 324 in this manner, facilitates increased accuracy of flow data thereby increasing accuracy of flow detection system 100, 200.

In some embodiments, recess 330 may include a vacuum configured to reduce noise from ambient acoustic/vibrational energy in the environment surrounding sensor system 320. In some embodiments, sensory system 320 may include metal layer 332, and shielding layer 334. Layers 332, 334 may be configured to further reduce interference and noise resulting from ambient vibrational/acoustic energy of the surrounding environment.

In some embodiments, flow sensor system 320 may include electrodes 326. Transceiver 336 may receive control signals for providing an electric voltage potential to electrodes 326. Electrodes 326 may provide a voltage potential across flow sensor 324. The voltage potential provided by electrodes 326 facilitates communication of sensor data, via signal line 328, to transceiver 336. For example, flow sensor 324 may include piezo-composite material that may generate an electrical current in response to Newtonian forces applied on the piezo-composite material subject to a voltage potential.

In some embodiments, piezo-composite material of flow sensor 324 may generate an electric current in response to detecting vibrational and/or acoustic energy. The generated electric current may be commensurate to the magnitude of the Newtonian force applied on the piezo composite material (e.g., the magnitude of the vibrational/acoustic energy 114 flowing through conduit 110). In some embodiments, transceiver 336 may be coupled with flow sensor 324 via signal line 328.

In some embodiments, transceiver 336 may transmit raw flow data to a processor external to flow sensor 324 (e.g. processor 132, 142, 162). In some embodiments transceiver 336 may include a processor (not shown) and may be configured to receive raw flow data via signal line 328. In some embodiments, transceiver 336 may include conditioning circuitry (not shown) which may condition the signal of signal line 328. Conditioning circuitry may include one or more amplifiers and filters and/or other signal conditioning circuitry (e.g., Zener diodes, shunt capacitors, voltage/current regulators, shunt diodes, resistors, high/low pass filters, bandpass filters, smoothing filters, and the like) configured to optimize and condition the sensor signal of signal line 328 for acquisition by the ADC of controller 130 and/or processor 132, 142, 162, for example.

In some embodiments, sensing elements of sensory system 320 (e.g., transducer 322 and/or sensor 324) may consist of two separate elements placed in-line or sideways on conduit 110, and include an interfacing circuit, such as a differential amplifier. In one embodiment, sensing elements may be connected to the interfacing circuitry to amplify amplitude differences. The distance sensing elements may be space apart my, in some embodiments, be altered (by design/manufacturing) for optimizing response signals at a given pipe diameter and flow characteristics of conduit 110.

In some embodiments, flow sensing system 320 may, in some embodiments, include a coupler (not shown) configured to removably attach the flow sensor proximate to the conduit. In some embodiments, the coupler may include a clamping mechanism that removably affixes flow sensing system 320 onto conduit 110. In some embodiments, the clamping mechanism may include one or more straps, winches, pulleys, cables, suction cups, adhesive strips, and/or other mechanical apparatus. In one embodiment, the clamping mechanism may include one or more magnets that may removably attach flow sensing system 322 a metallic conduit 110, for example.

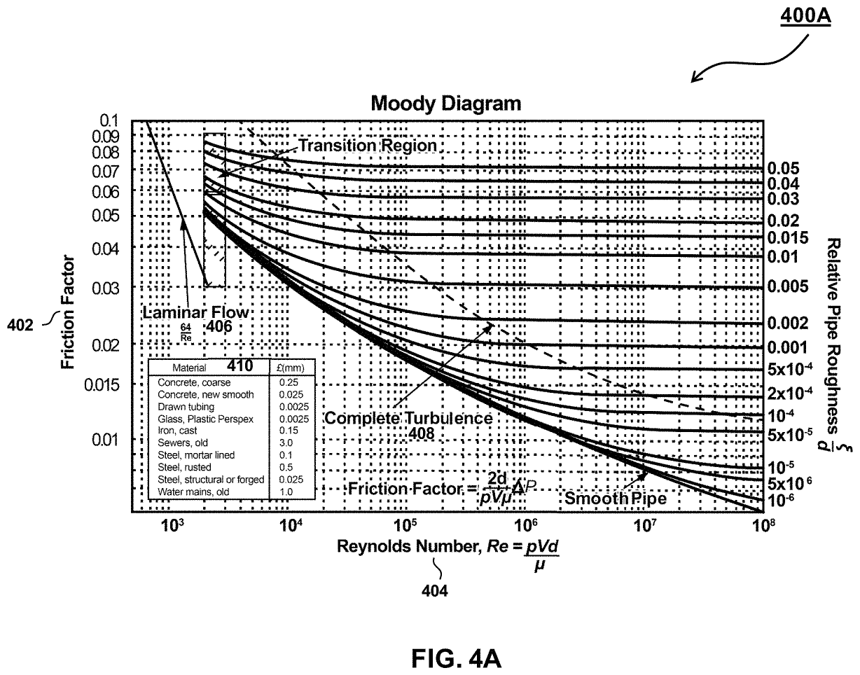

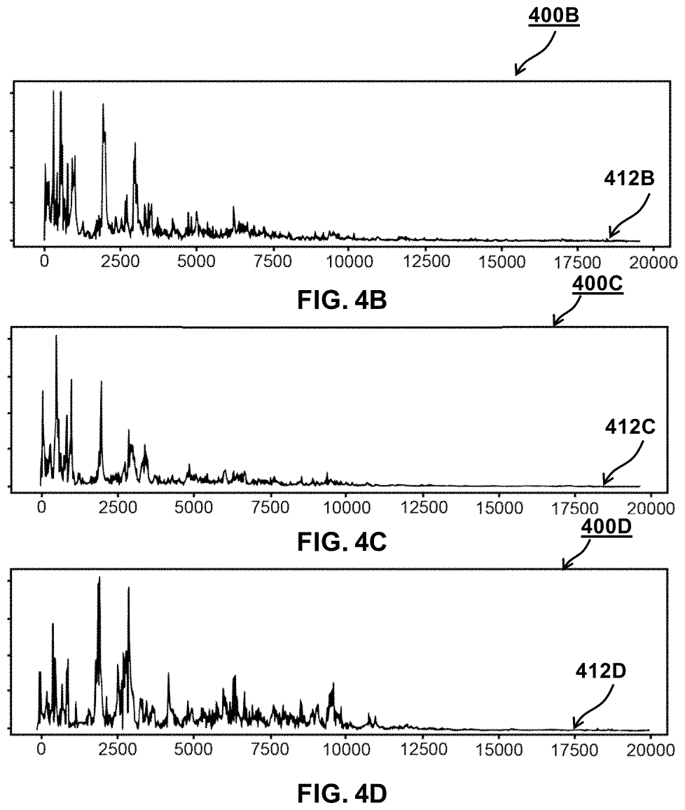

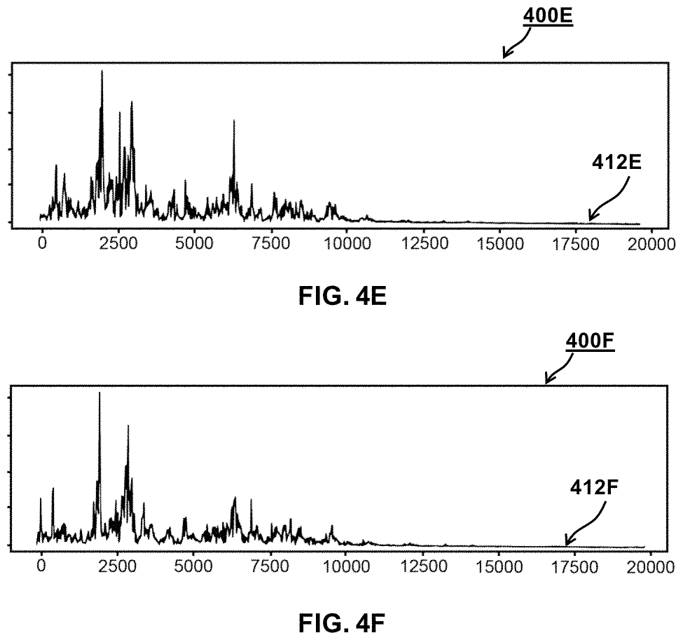

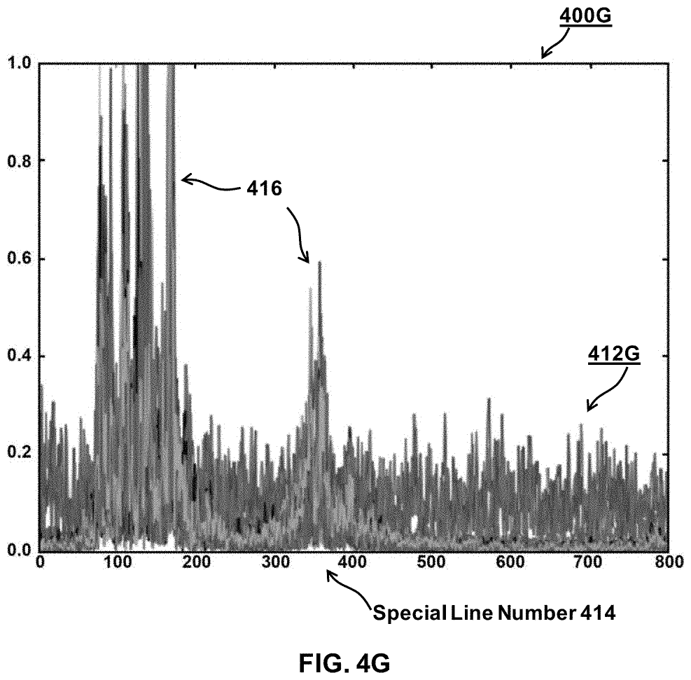

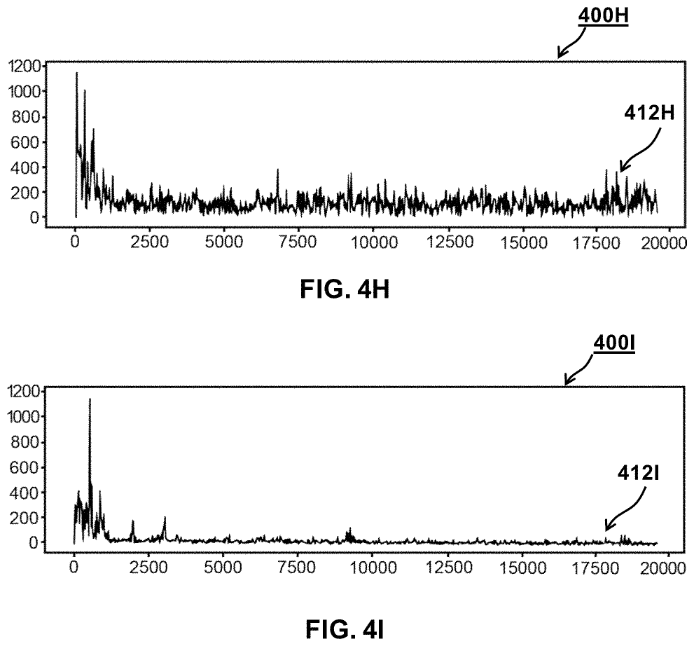

Referring now to FIG. 4A in conjunction with FIGS. 1-3, FIG. 4A depicts an illustration of an exemplary Moody Diagram 400, which relates a Darcy-Weisbach friction factor 402 and a Reynolds Number 404. Diagram 400 is primarily used to compute/predict pressure changes and/or flow rate in a circular pipe given friction factor. Diagram 400 illustrates laminar flow changing into turbulent flow. For example, both laminar flow as well as turbulent flow create friction forces which are responsible for the energy signal that sensor 120, 220, 320 may be designed to detect (e.g., turbulent flows are expected to create exponentially greater friction force energies). Thus, Diagram 400 illustrates the friction factor for varying materials and flows and therefore is an indication of possible efficacy of flow detection system 100, 200 by flow, pipe roughness, viscosity, material type, and the like.

As shown in FIG. 4A, based on a particular material 410, fluid flow 112 through conduit 110 creates a laminar or turbulent flow, which imparts flow energy 114 onto conduit 110. Similarly, gas flow also imparts flow energy 114 onto conduit 110. This energy 114 can be measured and used as a means to detect that fluid or gas (e.g. flow 112) is flowing. Additionally, a relative measure of the amount of flow 112, or flow 112 volume, can be established by measuring flow energy 114. This principal applies independent of conduit 110 material type, although some materials are better energy conductors than others, as shown in FIG. 4a.

Referring to FIGS. 4B-4F, FIGS. 4B-4F depict spectral measurement series diagrams charting amplitude (y-axis) vs frequency (x-axis) of individual OFS spectra (i.e. peaks of a spectral measurement series) 412B-412F, while water was flowing. FIG. 4G depicts a composition of one hundred superimposed water-on OFS spectra (i.e. one hundred spectra plotted over each other for conduits with on-flow status). As discussed above, flow energy 114 may be considered to be chaotic (i.e., non-periodical). As shown in FIGS. 4B-4F, spectral measurement series 412B-412F reveals this by showing varying peaks 414 of subsequent spectra, which is further highlighted in FIG. 4G.

Referring now to FIG. 4G, spectra 412G were normalized (i.e, max amplitude 1) and plotted according to spectral line number 414 (wherien, line 800, approx 19 kHz, for example). FIG. 4G shows how two apperant areas of interest 416 exist, for example between: 90-200 and 350-380. Also noteworthy, FIG. 4G depicts how widely varying the spectral peaks may be. Referring now back to FIG. 4A, overall Root Mean Square (RMS) measurements will show increasing or decreasing levels as flow 112 increases or decreases non-linearly—as shown in FIG. 4A. However, using acoustic energy measurements for detecting flow 112 and flow volume is not trivial.

For example, the threshold detected energy to determine that flow is detected must be set sufficiently high as to not create false positives due to the noise/false energy sources. This may cause a highly inaccurate total water volume measurement used by the consumer as many small water flows will go undetected. Therefore, an RMS based detection scheme is unable to provide one of the most important and key benefits of a flow management system—measuring small leaks. Small leaks (i.e., pin hole leaks) often go unnoticed for a long duration and may cause a hazardous environment including harmful mold that goes unseen when inside a wall.

At least three problems are addressed by the present system and method a) mitigating airborne environmental noise exerted into the conduit b) mitigating structure-borne noises (i.e., energy) caused by malfunctioning devices, structural transients or other structural noises (e.g., expansion and contraction of conduits from thermal fluctuations of the ambient environment c) and low flow detection.

Referring now to FIGS. 4H-4I, FIGS. 4H and 4I depict spectrum 412H-412I, respectively of a No-Flow State (NFS) (i.e., water off) and a spectrum of an On-Flow State (OFS) (i.e., water on). In FIG. 4H, what is observed in NFS spectra 412H is random noise, environment, and perhaps also electrically induced noise (e.g., 60 Hz etc.). FIG. 4I depicts OFS spectra 412I corresponding to a small amount of water flow (i.e., low flow of flow 112).

Though the amplitudes (y-scale) appear vastly different between FIGS. 4H and 4I, only one spectral line is driving that difference. The bulk of the spectrum, however, is at levels not too far (i.e., the difference is negligible) from the water-off NFS spectrum. In the Root Mean Square (RMS) computation that spectral peak would not account for much (e.g., with an 800-line spectrum it contributes only 1/800th). Thus, in some embodiments, an RMS detector of spectral processor 132 may be used to determine water off/on conditions (i.e. NFS/OFS). In some embodiments, the RMS detector may be adjusted fine enough to make a difference between the two spectra above (e.g., low flow state and no flow state). In some embodiments, the spectral processor (e.g., processor 132) may include the RMS detector.

Accordingly, in some embodiments, detecting flow 112 may include obtaining, utilizing flow sensor 120, raw flow data for conduit 110, for example by local processor 132. As discussed above, local processor 132 may include a spectral processor configured to determine a spectral energy curve (SEC) of fluid flow 112. As discussed above, in some embodiments, spectral processor may utilize an RMS detector configured for detecting a low flow state vs no flow state.

In some embodiments, detecting flow may include determining, by the spectral processor, a SEC of the fluid flow 112. The spectral processor may isolate, utilizing the SEC of fluid flow 112, flow-born energy of conduit 110 from an airborne environmental energy of the conduit 110, and a structural-born energy of conduit 110. For example, airborne environmental noise imparts energy onto conduit 110 or the structure (not shown) conduit 110 is fastened onto will generate elevate RMS. A car driving by, opening or closing of a garage door, or even a nearby airplane all can generate a detectable RMS level. In some embodiments, the spectral processor may then detect fluid flow 112 based on flow energy 114 of conduit 110.

A simple overall RMS reading cannot be used to determine flow of conduit 110. Structural born noises devices mounted onto or in-line with the conduit may produce energy which may be included as part of the overall RMS level. For example, a pump used to increase water pressure has a definite impact through its pumping action and mechanical force is conducted through conduit 110 structure (as well as through flow 112).

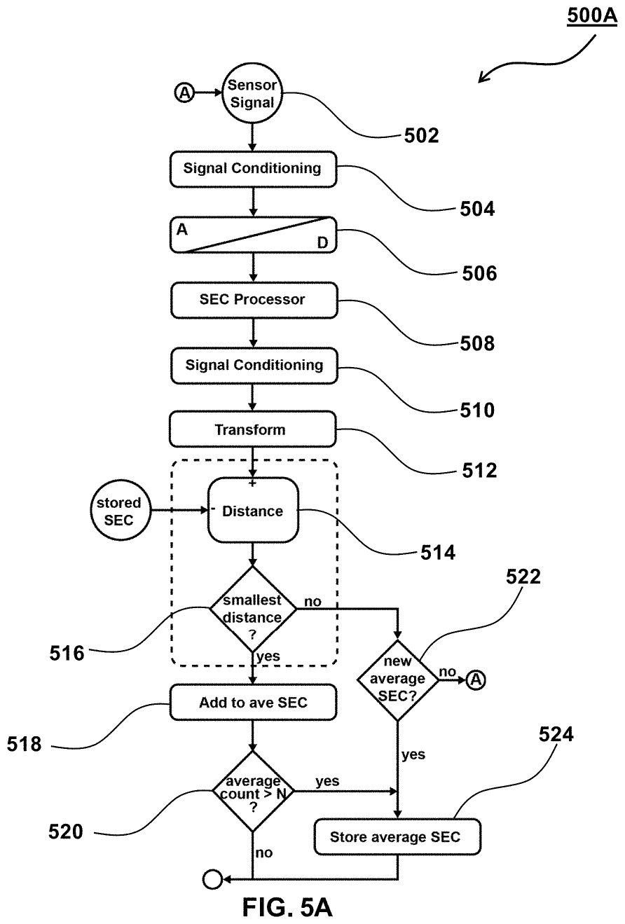

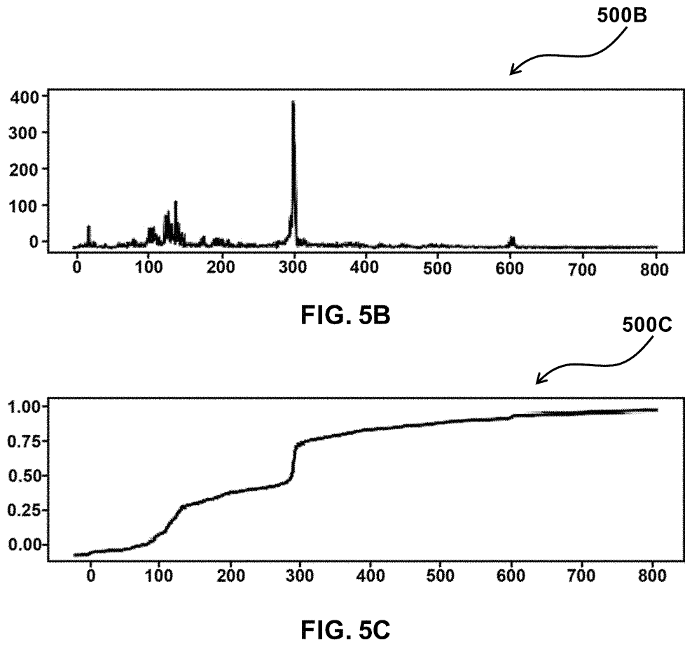

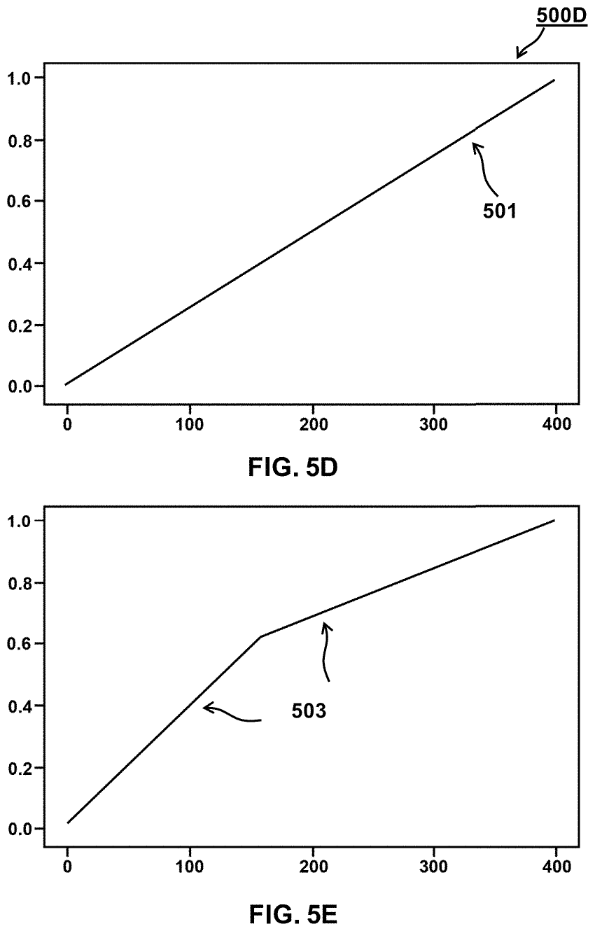

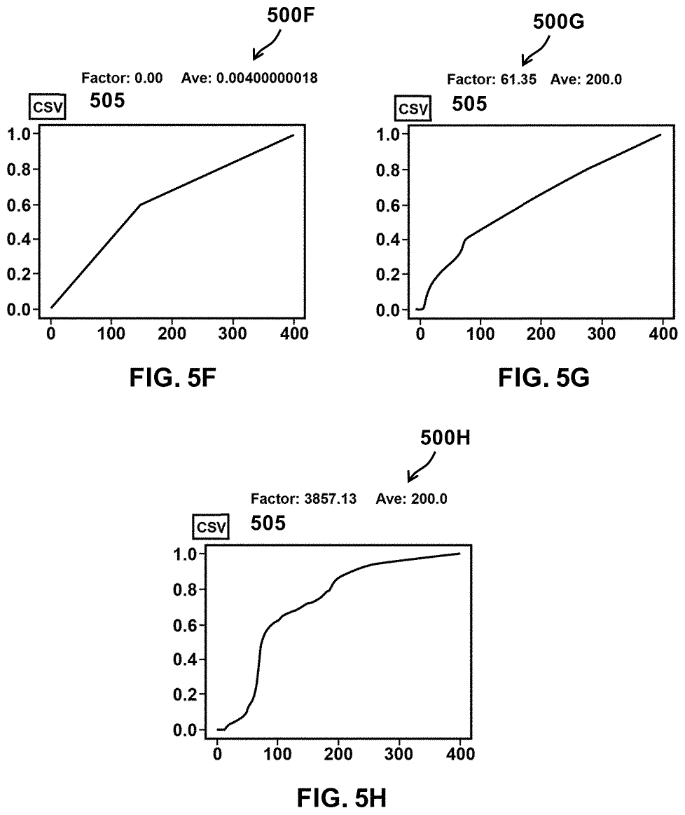

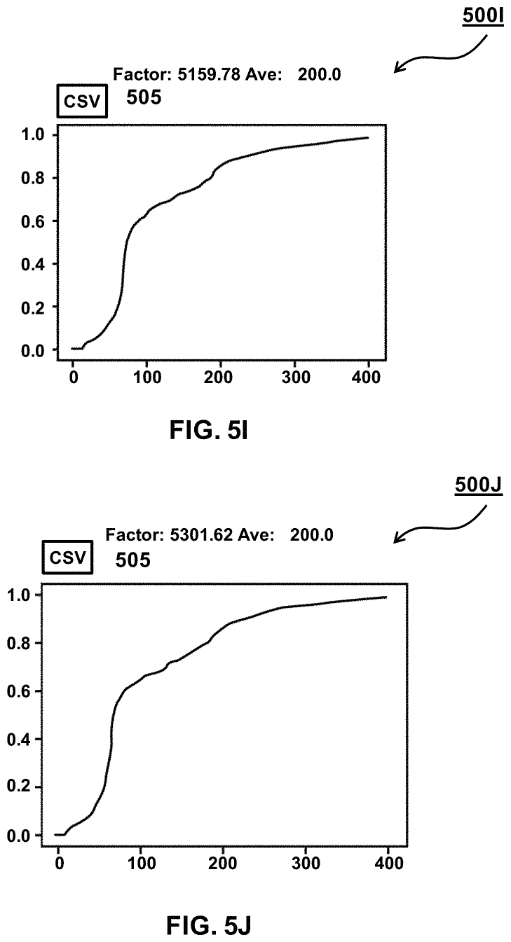

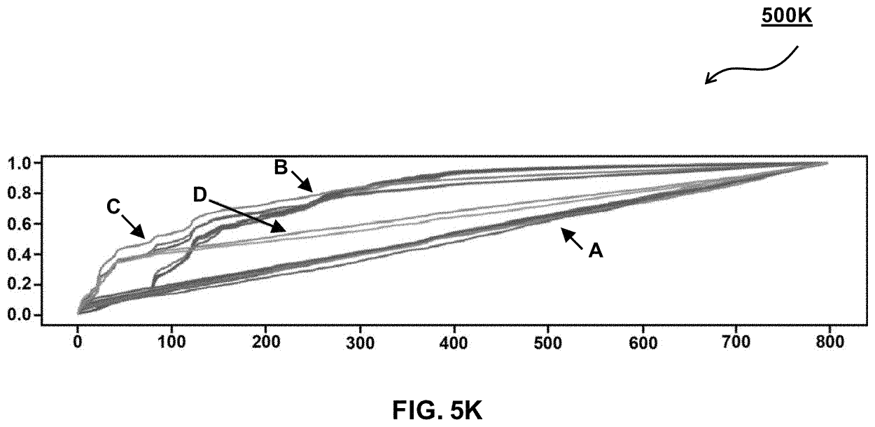

Referring now to FIG. 5A in conjunction with FIGS. 1-3, FIG. 5A illustrates an exemplary method 500A for detecting fluid flow through conduit 110, performed by the present system, in accordance with one or more embodiments. Method 500A utilizes a spectral processor (e.g., processor 132) that continuously acquires and computes a spectral energy curve (SEC) from an acoustic sensor (e.g., flow sensor 120). The acoustic sensor is located in a location relative to conduit 110 configured to facilitate detection and recording of flow energy 114.

In some embodiments, flow detection method 500A may begin at an operation 502, where the analog sensor signal 328 communicating raw flow data detected by flow sensor 324 is acquired by processor 132. At operation 504, sensor signal 328 is made available to analog conditioning circuitry of local controller 130 and processor 132. Analog conditioning circuitry may condition the analog sensor signal 328 using analog-to-digital conversion by an ADC converter of processor 132. At an operation 506 the ADC converts the raw flow data of sensor signal 328 into a stream of digital samples. For example, sample sizes may include 8-bit, 16-bit, 32-bit, or more.

In some embodiments, at an operation 508, a spectral energy processor (e.g., processor 132) determines a spectrum energy curve (SEC) of the raw or conditioned flow data that may be further conditioned and processed so that certain frequencies are amplified, while other certain frequencies are attenuated. Accordingly, at an operation 510 the computed spectrum may be amplified and/or attenuated at certain frequencies. For example, in some embodiment, frequencies below 500 Hz may be filtered out for the purpose of water off/on detection. In some embodiments, a sensitivity setting may be implemented in spectral processor 132, which a user of flow system 100, 200 may adjust and gradually amplify higher frequencies. In some industrial applications, where environmental noises are significant, a wide-band filter ranging between 100 kHz-500 kHz with broadband demodulation may be implemented to effectively reduce environmental noise.

In some embodiments, at an operation 512, the spectral processor may implement a transformation of the conditioned SEC which converts the SEC data for memory size purposes (e.g., compression) or CPU cycle limitations (e.g., reduce the number of spectral lines, convert to integers, among others. For example, in some embodiments, spectral processor may implement Fast-Forrier Transform (FFT) computations delivering floating point values of 4 bytes/value. To conserve memory, the spectral processor may convert these floating-point values to 2-byte values, thus saving significant CPU cycles as floating-point operations are extremely resource intensive. In some embodiments, transformation of the conditioned SEC may include resampling the spectral lines by integer or non-integer values, producing less than the originally computed set. In some embodiments, both floating point values may be reduced, and spectral lines may be resampled in order to conserve CPU cycles and memory.

At an operation 514, the SEC is compared with an average OFS SEC and average NFS SEC of the particular conduit 220n. In some embodiments, the comparison may be implemented by the spectral processor, which may compute a distance function between a previously stored SEC and current SEC. The distance function may include a Euclidian distance model, square some difference, a statistical correlation function, curve fitting, and other methods. The result of the distance function will determine whether the detected flow corresponds to a no-flow state (NFS) or an on-flow state (OFS), which is described in further detail below. The selection of the shortest distance determines whether the current SEC is representative of OFS for NFS

Referring now to FIGS. 5B-5C, FIG. 5B depicts a SEC 500B with a corresponding Cusum Spectra 500C shown in FIG. 5C. In some embodiments, in order to simplify computing a distance function of step 514, discussed above, SECs may be converted to a Cusum Spectrum whereby each spectral line is the accumulation of energy from 0 to full spectrum (left to right). As shown in FIG. 5C, Cusum spectra 500C may be normalized to 1.

Referring now to FIGS. 5D-5E, FIGS. 5D and 5E depict an NFS model and an OFS model depicted as Cusum spectrums 500D, 500E. In some embodiments, the average OFS SEC may start with a simple fixed model (SFM) OFS model and NFS model (e.g., 500D, 500E). As shown in FIG. 5D, the NFS model 500D may include a straight line 501. The OFS model 500E may consists of two-line segments 503 forming a bend, as shown in FIG. 5E.

Notice that a Cusum spectrum of OFS water on condition always shows a bend (i.e., “knee”). A distance computation between a straight line 501 and water-on spectrum vs a “knee” (e.g., 503) and water-on spectrum will always show that the “knee” Cusum spectrum is closer to the water-on spectrum. In some embodiments, the spectral processor may evaluate captured spectra each day and determine if there are spectra that better represent the water-on condition by showing a greater distance to the water-off conditions relative to the simple fixed model.

In some embodiments, detecting flow includes utilizing a simple fixed model (SFM) of a no-flow state (NFS) and on-flow-state (OFS) SEC. The SFM describes a high-level abstract definition of the spectral content of an NFS SEC and OFS SEC. In some embodiments, the SFM of the NFS SEC and OFS SEC may be stored in memory 134, 144, 164.

Referring now to FIGS. 5F-5J, FIGS. 5F-5J depict the process of averaging spectral sets in accordance with some embodiments described herein. FIGS. 5F-5J illustrate how the SFM may be replaced by an actual OFS of increasing accuracy over the duration of several days or more. The “factor” value 505 above graphs 500E-500J corresponds to the absolute value (i.e., strength/speed of flow 112) for the condition the Cusum spectrum was captured. Notice how fast the process of averaging spectral sets settles on a particular shape. For example, the initial change from SFM to real OFS is dramatic (e.g. 500F-500H) but subsequent changes mostly incremental (e.g. 500I-500J)

Referring now back to FIG. 5A in some embodiments, at an operation 516, the current SEC is compared against the model NFS SEC or averaged NFS SEC. For example, in some embodiments, at an operation 516, an instantaneous SEC is compared against the NFS SEC and that as OFS SEC by means of a distance calculation such as the total squared error or others, as discussed above. In some embodiments, at an operation 518, if the instantaneous SEC is determined to be closer to the OFS SEC than the NFS SEC, then the instantaneous SEC is added to an OFS spectral set.

In some embodiments, once a sufficient amount of new SEC values have been added, at an operation 520, a new average SEC may be created and stored. When it is determined that the SEC is representative of OFS, at an operation 522, an ongoing average SEC may be computed, and stored at an operation 524. The newly computed average SEC improves upon the existing stored SEC. The above process is then repeated for newly acquired signals (e.g., as depicted in FIGS. 5F-5J and discussed above).

Utilizing the average SEC provides increased accuracy in determining flow characteristics of flow 112 when compared to the initial SFM. The improvement is computed by a distance computation between the OFS NFS representative SECs, as discussed above. For example, when the spectral processor determines that flow 112 has stopped (i.e., instantaneous SEC is closer to NFS), or when sufficient SEC have been added to the spectral set, all SEC's are averaged in this average SEC is then stored in memory (e.g. memory 134, 144, 164).

In some embodiments, when the spectral processor determines that a stored average SEC is available from a previous measurement, the spectral processor may utilize the NFS/OFS SFM to use prior average SECs to compute and detect subsequent flow conditions. Each subsequent detection of OFS continues the acquisition and storage of the newly average SEC and further optimize SEC, which may continue to improve the detection of OFS.

As discussed above, some embodiments described herein include low-flow detection. The total amount of energy 114 propagated by flow 112 influences the characteristic of the instantaneous SEC. For example, a low-energy amount of flow 112 coincides with amplitudes predominately in the low spectral region, compared with a higher energy amount of flow 112 corresponds generally with amplitudes predominately in a higher spectral region.

For example, referring to FIG. 5K, FIG. 5K depicts a superimposed set of Cusum spectra acquired under varying water flow conditions. Including, for example, No water flow condition (A), Toilet flow condition (B) (i.e., relatively high water flow), Fridge/Faucet condition (C) (i.e., low water flow), and kitchen faucet condition (D) (i.e., moderate water flow). As shown in FIG. 5K, the “knee” shifts left for low flows, or right for high(er) fluid flows. For example, in a regular spectrum this would show as more predominant peaks with higher frequency for high water flows.

In some embodiments, the spectral processor utilizes the instantaneous SEC compared with total emitted energy of flow 112 by creating several averaged SEC values associated with segments of the total range of emitted RMS energy corresponding to energy 114. Therefore, when a low amount of energy 114 is detected, the average SEC associated with low-energy amount is used to determine the OFS. Conversely when a high total energy about of energy 114 is detected, the average SEC associated with the high-energy amount is used.

For example, when configured to determine how many average SEC levels should be utilized, the spectral processor may utilize a range segregation feature to isolate a low to high range computation and/or statistical method. For example, assuming at first that the spectral processor has only a single setting i.e., no range segregation. As water events are collected during the day, a range of lowest to highest water levels (flow) can be established. Water events are captured with start time, stop time, total volume, number of measurements and average energy per measurement. It is therefore simple to determine the average instantaneous flow for each captured event. That in turn means that a lowest and highest flow level can be computed i.e., “the range”.

In some embodiments, to improve on the spectral processor having only a single range setting i.e. using only a single average SEC as a matching filter for each incoming water event, the spectral processor can divide or segregate the range into discrete steps. In one embodiment, range segregation includes dividing the range into three levels; lowest, middle, highest, which gives two enclosed areas. The spectral processor may utilize computation that collects average SECs for each of these two areas/ranges (e.g., if a signal level is measured that falls below the midpoint, the average SEC-B is used to determine flow, if an energy level above the mid-point is measured, the average SEC-A is used to determine flow). In this way, signals of sufficiently high level may still be rejected as actual flow if they do not compute as “close” to the appropriate average SEC.

In some embodiments, rather than just taking the min-max range and dividing by the number of required areas as discussed above, the spectral processor may first compute a logarithmic distance level between the minimum and maximum levels to determine if there is enough separation distance (e.g., min=1 and max=10, log 10(10/1) is approximately 1 to indicate a factor of 10 distance which is sufficient for at least 2 areas). In yet another embodiment which is more cost effective for low power CPUs, a divide-by-two method may be implemented whereby the maximum level is continuously divided by 2 until the result equals or is below the minimum value. The number of divisions is the number of areas.

In some embodiments, a histogram of actual flow levels and their frequency of occurrence and create areas in accordance with the histogram bin size. For example, the spectral processor may determine additional levels are required based on statistical computation of similarity between averaged SEC curves. In some embodiments, for each newly acquired averaged SEC, a statistical correlation is computed between the newly acquired averaged SEC and previously stored averaged SEC. If the correlation coefficient of approximately 0.8 is not found, a new level is determined and associated with the total emitted energy for that average SEC. In some embodiments, if the correlation coefficient between 0.6-0.9 is not found, a new level is determined and associated with the total emitted energy of the average SEC. In another embodiment, the correlation coefficient may include less than 0.8 or more than 0.8.

FIG. 5J shows that the most common flow rate is 2 gpm and higher as well as lower flow rates are less common in this installation. In some emobdiments, to improve water-on detection, the average SEC levels discussed above may be constructed/computed by using the x-axis level. It is not required to implement all histogram levels but rather a set of levels that capture the usage pattern. A simple to compute method may include using the minimum and maximum levels of the most common occurance histogram bin, all levels left to the most common bin combined, and all levels right to the most common bin combined. As shown in FIG. 500J, this would result into three levels: 0-1.75, 1.75-2.25, and 2.25 and larger. In one embodiment, the squared some difference may be an alternative to the statistical correlation method. The squared some difference may give a computational benefit for low-speed processors.

In some embodiments, the spectral processor may utilize additional, or fewer, levels of energy amounts based on a predetermined configuration or based on further computation. For example, determining when additional levels may be utilized may utilizing “hard-coded” firmware to always divide the total range up into X sections. ‘X” being chosen in the factory based on general observations and the empirical science that ‘X’ is a generally accepted optimum.

In some embodiments, described in further detail below, in addition to using the overall total energy as a differentiator for the average SEC as a means to detect flow 112, the spectral processor may generalize this process utilizing “feature extraction”. One mode of feature extraction is overall RMS value. In some embodiments, another method for feature extraction may utilize RMS energy of a specific spectral region or peak energy or specific spectral peak.

In some embodiments, instead of the RMS value method as described above, histogram modeling as described above in FIG. 5J may be utilized for feature extraction. For example, feature extraction may include, for each averaged SEC, determining the highest spectral amplitude and implementing the highest spectral amplitude to create ranges as described above. The highest amplitude may be across the entire spectrum or a limited range (band). This band may be predetermined to avoid environmental noise and/or to include known spectral responses from conduit and structure.

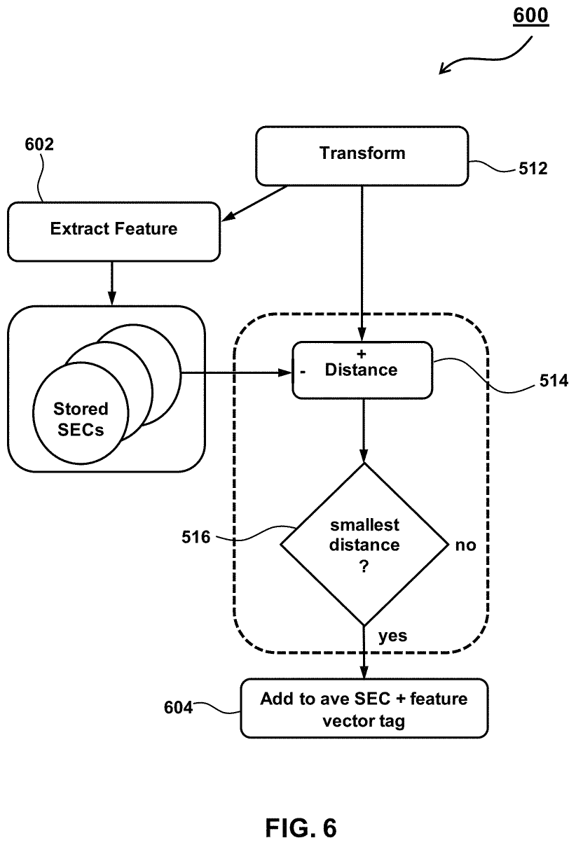

Referring now to FIG. 6 in conjunction with FIGS. 1-3, FIG. 6 depicts an exemplary method 600 for detecting flow of a conduit in accordance with one or more embodiments. Method 600 includes a refinement of the OFS/NFS determination of FIG. 5A. In some embodiments, the OFS/NFS determination may be implemented by using multiple stored average SEC's, which may be indexed or associated by an extracted feature. The extracted feature may be the SEC's overall RMS level, but may also be a filtered section RMS, peak, or single peak, which is described in further detail below.

Method 600 may be performed in a similar manner as method 500A up to operation 512 where the processed SEC may be conditioned for memory and/or processor frequency limitation, as described above. Method 600 differs from method 500A in that prior to performing the distance calculation (e.g., at an operation 514), a feature extractor computes a vector or vector set representative of a metric of the SEC, at an operation 602. For example, in one embodiment, the vector or vector set of the SEC metric may include an overall RMS of the SEC. In another embodiment, a vector or vector set of the SEC metric may include tuple (RMS, Crest factor) with crest factor=peak-peak/RMS.

The Crest Factor (CF) may be defined as RMS divided by the peak to peak level of a signal. A multi-dimensional vector (RMS, CF) may better indicate/differentiate between signals with similar RMS levels but vastly different CF levels. For example, consider two signals A and B both consisting of a pure sine wave and amplitude “m”. Signal B has an additional singular peak positioned at the 90 degrees at amplitude 2*m. The RMS for signal A=1/m\hat{ }0.5, the peak to peak difference is: m−−m i.e. 2m. Therefore, the CF for signal A=2m/m\hat{ }0.5. For signal B, the singular peak hardly adds any energy, so the RMS level is approximately the same as signal A: 1/m\hat{ }0.5. Signal B's peak to peak level, however, is now 2m−(−m)=3m and therefore CF=3m/m\hat{ }0.5.

Signals that have a similar CF may not need to have a similar RMS level and so the combination (RMS, CF) provides increased accuracy in distinguishing low level, peaky vs low level not peaky, as well as high level peaky vs high level not peaky. If the vector (RMS, CF) had not classified the appropriate average SEC failing appliances such as a PRV, which may emit a high amplitude repetitive spike that shows change from the normal average SEC but may not always be easily detected as “different”.

As shown in FIG. 6, at an operation 516, if the distance calculation corresponds to the SEC as representative of OFS, the SEC is added to the new set of average SEC. At an operation 604, when a sufficient predetermined number of new SECs have been added, a new average SEC may be created and stored along with a feature vector tag corresponding to the extracted feature of the instantaneous SEC (e.g., operation 602).

The feature vectors determine which stored averaged SEC the current instantaneous SEC should be compared with. This allows flows with different SEC content to still be evaluated as OFS. Additionally, feature vectors implemented in the above described manner allow flow detection to be more sensitive to the differences between high and low flow, which often causes skewed spectra in the SECs. Thus, implementing feature vectors in the above described manner achieves increased accuracy of flow detection without increasing manufacturing cost.

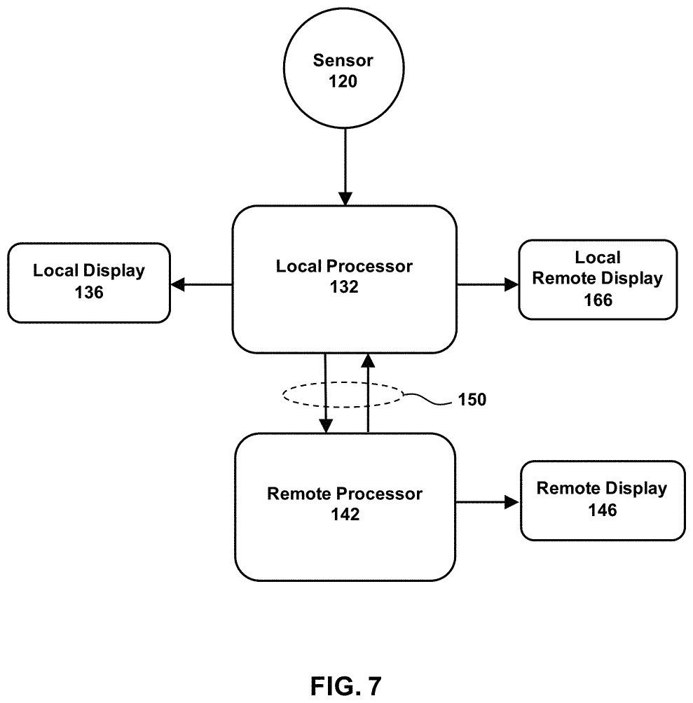

Referring now to FIG. 7 in conjunction with FIG. 1, FIG. 7 depicts an exemplary implementation, whereby some processing of flow sensor 120 output signals takes place locally, for example, by local processor 132, and the remainder takes place remotely, for example, by remote processor 142. As shown in FIG. 7, processors 132, 142 may communicate with displays 136, 146, 166 via a wired or wireless connection. In some embodiments, the local processor may perform signal conditioning and ADC conversion, as described above. The output of the ADC, (i.e. the digitized signal 120 output) may be sent to remote processor 142 across wired or wireless connection (e.g., network 150). In some embodiment, remote processor 142 may implement all remaining logic for flow detection as described above. In some embodiments, remote processor 142 may return the result (e.g., the detected flow of the conduit) to local processor 132.

In some embodiments, local processor 132 may have local display 136 where flow 112 status (e.g. flow direction and volume) may be depicted. In some embodiments, local remote display 166 may be driven by local processor 132 through a wired or wireless connection (e.g., network 150). Local remote display 166 may be a mobile display as well as stationary dashboard, for example. In some embodiments, remote processor 142 may be in communication with remote display 146 through a wired or wireless connection (e.g., Ethernet, USB, RF, BLUETOOTH™, BLE).

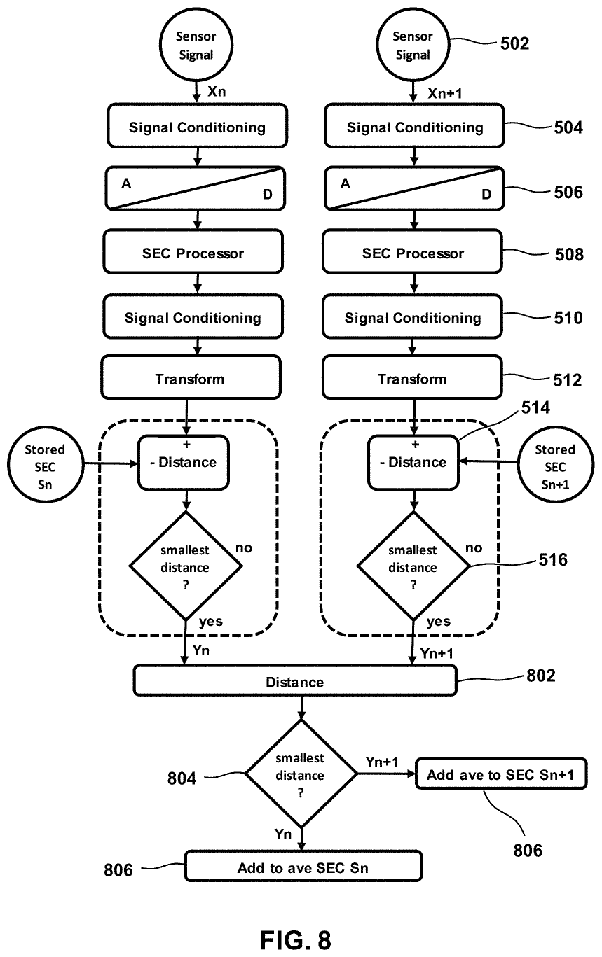

Referring now to FIG. 8 in conjunction with FIG. 2, FIG. 8 depicts a multi-sensor implementation whereby two or more sensor 210 output signals may be computed and combined to determine which sensor 210 is associated with the flow of an outlet of a conduit 210. In some embodiments, subsequent to initial data processing 502-516, which is performed in the same or similar manner as discussed above, at an operation 802, the resulting distance computation may be compared for each sensor signal 502 Xₙ and 502 X₍ₙ₊₁₎, utilizing for example a squared sum difference, RMS, peak to peak SEC comparison, and the like.

A distance computation is necessary to determine which of the current SEC is most representative of the average SEC for on-flow. Some embodiments include two main distance computations: the sum of the squared differences (1) and Manhattan distance (2). In (1) the computation is sqrt(sum(Xi−Yi)) for i=0 to i=N, with X being the current SEC for a given sensor, Y the average SEC and N the number of lines in SEC. The sqrt( ) function may be omitted. In (2) the computation is sum(abs(Xi−Yi)) with X, Y and N defined as above. This computation is repeated for every sensor and the computation with smallest result (i.e. shortest distance) is deemed to be representative of the on-flow.

In some embodiments, the above described methods may be further enhanced by also considering specific vectors from the sensor signals such as peak-to-peak (pp) and RMS values. The computation then becomes a comparison between distance (shortest), average pp (largest), and RMS (largest). This is not always straightforward i.e., a combination such as distance (shortest, RMS(largest) but pp(not largest) might arise. Therefore, in some embodiments, a weighing/scaling system may be applied whereby distance is weighted most importantly, RMS second and pp third.

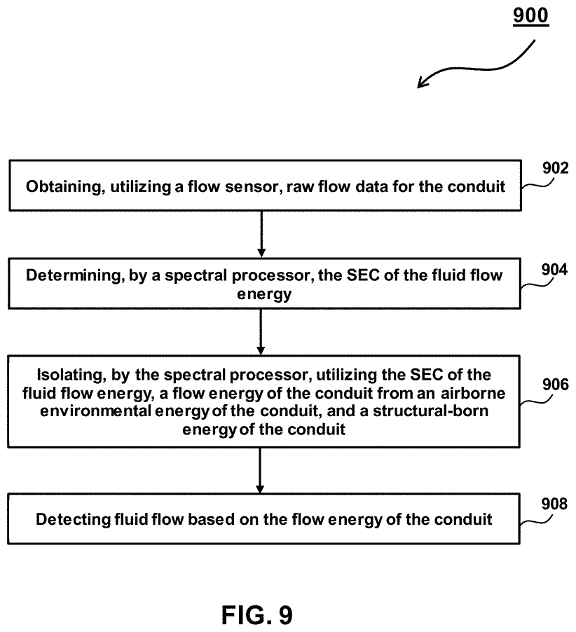

Referring now to FIG. 9, FIG. 9 depicts an exemplary method 900 for detecting fluid flow through a conduit. The operations of method 900 presented below are intended to be illustrative. In some embodiments, method 900 may be accomplished with one or more additional operations not described, and/or without one or more of the operations. Additionally, the order in which the operations of method 900 are illustrated in FIG. 9 and described below is not intended to be limiting.

At an operation 902, raw flow data for the conduit is obtained utilizing the flow sensor. In some embodiments, operation 502 is performed by a flow sensor the same or similar as flow sensor 120 of FIG. 1.

At an operation 904, the raw flow data is used for determining, by a spectral processor, the SEC of the fluid flow energy. In some embodiments, operation 504 is performed by a spectral processor the same or similar as remote processors 132 FIG. 1.

At an operation 906, the fluid flow energy is analyzed by isolating, by the spectral processor, utilizing the SEC of the fluid flow energy, a fluid born flow-energy of the conduit from an airborne environmental energy of the conduit, and a structural born energy of the conduit. In some embodiments, operation 906 is performed by a spectral processor the same or similar as remote processors 132 FIG. 1.

At an operation 908, the method may complete by detecting fluid flow based on the fluid born energy of the conduit. In some embodiments, operation 908 is performed by a spectral processor the same or similar as remote processors 132 FIG. 1.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A method of detecting fluid flow through a conduit utilizing a flow sensor configured to sense fluid flow energy, the flow sensor in communication with a spectral processor configured to determine a spectral energy curve (SEC) of the fluid flow, the method comprising:
obtaining, utilizing the flow sensor, raw flow data for the conduit;
determining, by the spectral processor, the SEC of the fluid flow based on the raw flow data,
isolating, by the spectral processor, utilizing the SEC of the fluid flow, a flow-born energy of the conduit from an airborne environmental energy of the conduit, and a structural-born energy of the conduit; and
detecting fluid flow based on the flow-borne energy of the conduit.

2. The method of claim 1, wherein detecting fluid flow comprises detecting an indication of flow and/or a flow volume based on the flow-born energy of the conduit.

3. The method of claim 2, further comprising electronically storing the indication of the fluid flow and/or the flow volume.

4. The method of claim 1, wherein isolating, utilizing the SEC of the fluid flow energy, the flow-born energy from the airborne environmental energy, and the structural-born energy, comprises comparing an instantaneous SEC against a predetermined No Flow State (NFS) SEC and an On-Flow State (OFS) SEC by means of a distance calculation.

5. The method of claim 4, wherein isolating the flow-born energy of the conduit comprises continuously performing the distance calculation with a plurality of additional instantaneous SECs.

6. The method of claim 4, wherein when the distance calculation indicates whether the instantaneous SEC is closer to the OFS or the NFS.

7. The method of claim 6, the method further comprising, responsive to the SEC being closer to the OFS, adding the instantaneous SEC to an OFS spectral set.

8. The method of claim 6, wherein determining the flow energy of the conduit comprises averaging the OFS spectral set responsive to a predetermined amount of distance calculations indicating that the instantaneous SEC is closer to the OFS set.

9. The method of claim 1, wherein determining, by the spectral processor, the SEC of the flow energy comprises continuously determining the SEC of the flow energy.

10. The method of claim 1, wherein the flow sensor comprises an acoustic sensor configured to sense vibration and/or sound.

11. The method of claim 1, when the flow sensor comprises a convex shaped acoustic sensor interface configured to concentrate acoustic flow energy through the conduit for the flow sensor.

12. The method of claim 1, wherein the flow sensor comprises a laser sensor.

13. The method of claim 1, wherein the flow sensor comprises a camera sensor.

14. The method of claim 1, wherein the flow sensor is configured to be removably coupled to the conduit.

15. The method of claim 1, wherein the flow sensor is located proximate to the conduit.

16. The method of claim 1, wherein the conduit comprises a shutoff valve

17. The method of claim 16, wherein the shutoff valve includes a valve device coupled to an existing manual valve handle.

18. The method claim 16, wherein the shutoff valve includes an inline valve device.

19. The method of claim 16, wherein the shutoff valve is actuated automatically based on self-computed settings.

20. The method of claim 16, wherein the shutoff valve is actuated based on user thresholds.

21. A system for detecting fluid flow through a conduit, the system comprising:
a flow sensor configured to sense fluid flow energy of the conduit; and
a spectral processor in communication with the flow sensor and configured to detect the fluid flow by:
obtaining, utilizing the flow sensor, raw flow data for the conduit output by the flow sensor;
determining a spectral energy curve (SEC) of the fluid flow energy based on the raw flow data;
isolating, utilizing the SEC of the fluid flow energy, a flow-borne energy of the conduit from an airborne environmental energy of the conduit, and a structural-born energy of the conduit; and
detecting fluid flow based on the flow-borne energy of the conduit.

22. The system of claim 21, wherein detecting fluid flow comprises detecting an indication of flow and/or a flow volume based on the flow-born energy of the conduit.

23. The system of claim 22, further comprising electronically storing the indication of the fluid flow and/or the flow volume.

24. The system of claim 21, wherein isolating, utilizing the SEC of the fluid flow energy, the flow-born energy from the airborne environmental energy, and the structural-born energy, comprises comparing an instantaneous SEC against a predetermined No Flow State (NFS) SEC and an On-Flow State (OFS) SEC by means of a distance calculation.

25. The system of claim 24, wherein isolating the flow-borne energy of the conduit comprises continuously performing the distance calculation with a plurality of additional instantaneous SECs.

26. The system of claim 24, wherein when the distance calculation indicates whether the instantaneous SEC is closer to the OFS or the NFS.

27. The system of claim 26, wherein responsive to the SEC being closer to the OFS, adding the instantaneous SEC to an OFS spectral set.

28. The system of claim 26, wherein determining the flow energy of the conduit comprises averaging the OFS spectral set responsive to a predetermined amount of distance calculations indicating that the instantaneous SEC is closer to the OFS set.

29. The system of claim 21, wherein determining, by the spectral processor, the SEC of the flow energy comprises continuously determining the SEC of the flow energy.

30. The system of claim 21, wherein the flow sensor comprises an acoustic sensor configured to sense vibration and/or sound.

31. The system of claim 21, when the flow sensor comprises a convex shaped acoustic sensor interface configured to concentrate acoustic flow energy through the conduit for the flow sensor.

32. The system of claim 21, wherein the flow sensor comprises a laser sensor.

33. The system of claim 21, wherein the flow sensor comprises a camera sensor.

34. The system of claim 21, wherein the flow sensor is configured to be removably coupled to the conduit.

35. The system of claim 21, wherein the flow sensor is located proximate to the conduit.

36. The system of claim 21, wherein the conduit comprises a shutoff valve

37. The system of claim 22, wherein the shutoff valve includes a valve device coupled to an existing manual valve handle.

38. The system of claim 22, wherein the shutoff valve includes an in-line valve device.

39. The system of claim 22, wherein the shutoff valve is actuated by automatically based on self-computed settings.

40. The system of claim 22, wherein the shutoff valve is actuated based on user thresholds.

41. A sensing system comprising:
a flow sensor configured generate and transmit output signals conveying information related to flow energy of fluid flow through a conduit;
a processor configured to determine a flow state of the fluid flow;
a coupler configured to removably attach the flow sensor proximate to the conduit; and
a convex shaped interface coupled to the flow sensor and configured to concentrate flow energy through the conduit for the flow sensor and conduct the flow energy to the flow sensor.

42. The flow sensor of claim 41, wherein the convex shaped interface comprises a convex shaped acoustic sensor configured to concentrate acoustic flow energy through the conduit and transmit flow energy data to the processor.
